(19) United States
(12) Patent Application Publication
(10) Pub. No.: US 2007/0121603 A1
(43) Pub. Date: May 31, 2007

(54) Method and system for creating VoIP routing registry

(76) Inventors: Joseph E. Clark III, Little Silver, NJ (US); Stephen M. Walters, Holmdel, NJ (US); Kaj Tesink, Fair Haven, NJ (US); Joseph E. Clark III, Little Silver, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 11/541,855

(22) Filed: Jan. 23, 2007

Related U.S. Application Data
(60) Provisional application No. 60/722,211, filed on Sep. 30, 2005.

(51) Int. Cl. H04L 12/66

(52) U.S. Cl. 370/356

(57) ABSTRACT

VoIP Routing Registry (VRR) has been created to allow VoIP Service Providers to direct calls properly over their IP networks. In operation, the VRR translates a 10-digit or 6-digit telephone number into a URI that can be used for routing. The VRR must also take into consideration Local Number Portability (LNP).

### CROSS REFERENCE TO RELATED APPLICATIONS

This patent incorporates by reference and relies on the priority of Provisional Patent Application Ser. No. 60/722,211, entitled Method and System for Creating VoIP Routing Registry filed on Sep. 30, 2005.

### FIELD OF THE INVENTION

The present invention relates a system and method for enabling Voice over Internet Protocol (VoIP) Service Providers to direct calls over their Internet Protocol (IP) networks.

### BACKGROUND OF THE INVENTION

Today's VoIP services are at an early stage, but one problem faced by VoIP service providers given only a 10-digit called party telephone number at a VoIP originating softswitch or some intermediate network element, is finding a route to the called party if it is not a local call for that service provider. Today, in the public switched telephone network (PSTN), the Telcordia® LERG™ Routing Guide specifies a Common Language Location Identification (CLLI™) code for each NPA-NXX block. This information is passed through operations systems and ultimately establishes the routes to the switches in the network. But VoIP network elements do not have any equivalent systematic routing capability. Today, VoIP originated calls are simply “dumped” into the PSTN at whatever entry point is available even though the call might possibly be routed over IP to a better entry point or all the way to the destination. A sophisticated routing capability could save money in access charges or transit network settlement charges as VoIP usage grows.

### BRIEF SUMMARY OF THE INVENTION

In our VoIP Routing Registry (VRR), service providers will specify either 10-digit telephone numbers or 6-digit NPA-NXX telephone number blocks and an associated uniform resource identifier (URI) for routing to the network entry point the terminating carrier wants used for reaching that number or block of numbers. Terminating service providers can specify different URI values for defined groups of originating service providers, a feature that gives the terminating providers control over where calls enter their networks. Because of this feature, each provider retrieving the data from the VRR may receive different information as provided for their use by the other providers. This is called a “view” and is unique to each carrier.

The VRR database is not queried in real-time; instead it is periodically downloaded into the service provider's real-time database servers (resolvers) where it, along with local number portability (LNP) capabilities, are used to find routes. In this way, the VRR can be used as the data for a server that handles either DNS/ENUM queries or SIP/INVITE messages (or both) for routing calls. Since the data is being distributed over an IP-VPN, it is secure and protected from hackers.

### BRIEF DESCRIPTION OF THE DRAWINGS

FIG. 1 depicts a schematic block diagram of a VoIP Routing Registry Architecture in accordance with one embodiment of our invention.

FIG. 2 depicts a schematic block diagram of a VoIP Routing Registry Architecture in accordance with embodiment of our invention where the resolver servers are not LNP capable.

### DETAILED DESCRIPTION

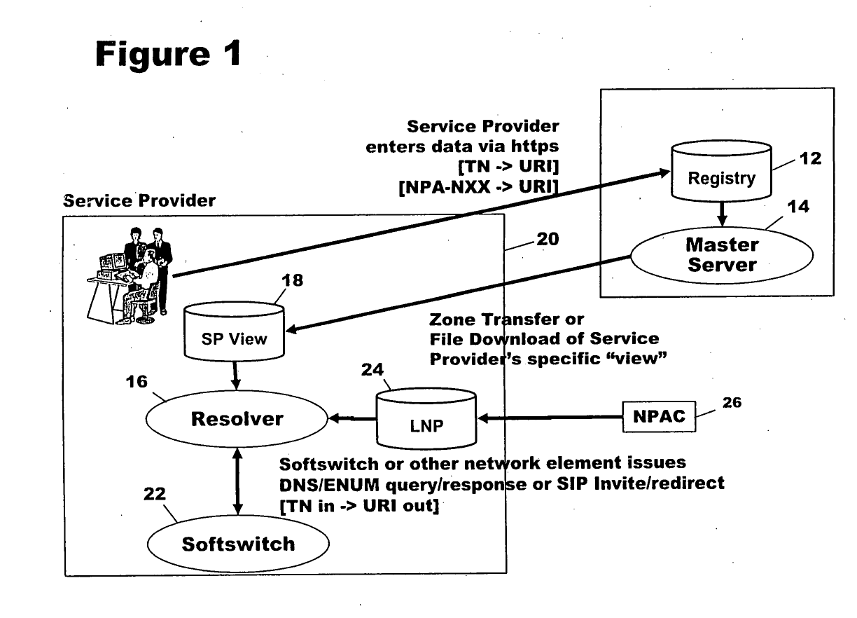

Our VRR is illustrated in FIG. 1. There are three major components—a registry database 12, a master server 14, and resolver(s) 16.

Service providers access the registry database 12 using secure HTTP access and store data in the registry database that maps individual telephone numbers or blocks of telephone numbers to their network entry point URIs. The registry database is not accessed during call setup, but instead transmits information ahead of time to the service provider's “resolver” systems that are used during call setup.

The master server 14 resides between the registry database 12 and the resolvers 16 and provides a data feed to the resolvers using SOAP/XML, DNS zone transfers, or some other suitable means. It is the master server that constructs the various service provider “views” 18 for each resolver.

The resolver systems 16 are located within each service provider's network 20 and are used during call setup. There are multiple resolvers. Normally there is one or more resolvers per service provider customer depending on their geographic diversity and traffic volume. These real-time systems, having previously received information from the registry, are interrogated by VoIP softswitches 22, SIP proxies, Session Border Controllers and/or other network elements to determine (resolve) the destination of called numbers. If a service provider wants to interface VRR with legacy operations systems, a simple download mechanism can be used.

The VRR registry stores records of two types, their associated URI and additional data. The two record types are:

The first record type is based on 10-digit VoIP phone numbers including an effective date/time and an associated URI. Ordinarily, there will be only a single entry for any 10-digit VoIP number; however, when a number is ported from one service provider to another, there can be two entries for a brief period of time. Once the effective date/time passes, the older record will be marked as inactive (or deleted with notice sent to the carrier of record). A number portability administration center (NPAC) 26 maintains a database of telephone numbers that have been ported between local carriers. This “cleanup” will be performed daily since the resolvers, not the registry, will select the proper record for routing at call setup time.

The second record type is based on 6-digit numbers representing either gateways to the PSTN or blocks of VoIP numbers. Each record has an effective date/time and a URI.

When creating either 10-digit VoIP number or 6-digit blocks, terminating service providers can assign different URI's for groups of originating service providers. This allows the terminating service provider to better administer routing based on their business relationships. Thus, when service providers retrieve the database from the registry, they may be given different URI's for the same number or block of numbers. The version of the database provided to a service provider is called a “view” 18 and is specific to a given service provider. Thus every service provider will have a unique “view” presented to them when they access the VRR administrative system or receive VRR downloads.

Besides storing the URI of the destination, it is also possible for a service provider to associate an optimal “egress” URI for routing to the destination URI of the record. This information supplements the basic capability of VRR and would allow originating service providers to easily route to their best (closest) point-of-interconnection to reach the destination.

The resolver 16 is responsible for resolving queries which might be either SIP INVITE or ENUM/DNS queries, in which it is given the 10-digit called telephone number for the particular call.

Two methods have been defined for resolver processing:

Method 1—Call-Time LNP Correction

With Method 1, master server 14 has delivered all 10-digit and 6-digit URI mappings to the SP View 18 of the resolver 16.

The resolver 16 is LNP_capable, and it searches for matches to the 10-digit called telephone number in its view 18 of the VRR, performing LNP correction at call time. There are four possible outcomes:
1. A single 10-digit match is found. In this case, the number is a VoIP reachable telephone and the call can be immediately routed to the URI associated with the found record.
2. Two 10-digit matches are found. In this case, the number is a VoIP reachable telephone number that is in the process of being ported. The resolver will examine the “Effective Date/Time” fields in the matching records to determine which of the URI's should be used, and then routing to the associated URI for that record can be performed.
3. A 6-digit match is found. In this case, the telephone number is in either a traditional PSTN number reachable thru a PSTN gateway or it is within a block of VoIP reachable numbers. Before routing, it must be corrected for porting/pooling using the following steps:
   a. The URI associated with the 6-digit match is saved for possible future routing.
   b. The Resolver checks the Local Number Portability (LNP) database 24 to determine if there is an associated LRN. This has two possible outcomes.
      No LRN is found. The number is not ported or pooled so the resolver routes to the associated URI saved in step (a).
      A LRN is found. The resolver performs another search of its VRR view using the leading 6-digit NPA-NXX of the LRN:
         if a match is found, the corresponding URI in the found record is used for the route
         If no match is found, then the ported number is not a VoIP number and there is no gateway provided for the specific NPA-NXX number block. So the call must be passed to any available PSTN portal for completion.
4. No match is found. In this case, the number is not a VoIP reachable number and there is no gateway provided for the specific NPA-NXX number block. So the call must be passed to any available PSTN portal for completion.

Several variations in the order of search will produce the same end result, and all are considered to be covered by the application.

Method II—Call-Time LNP Correction

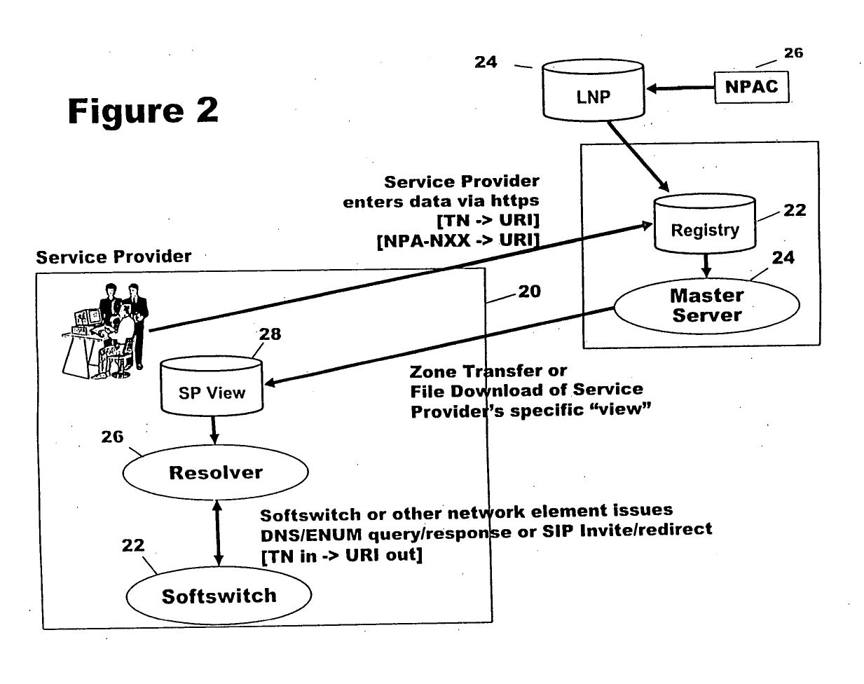

Method II is best viewed within the architecture depicted in FIG. 2. The major difference between the embodiment depicted in FIG. 1 and the embodiment in FIG. 2 is that the number portability administration center (NPAC) 26 which maintains the LNP database 24 of telephone numbers that have been ported between local carriers is used to feed this data to the registry 22.

With Method II, the registry 22 pre-computes LNP corrections and delivers, via the master server 24, LNP-corrected 10-digit URI mappings and 6-digit URI mappings to the resolver.

With Method II, the resolver is not LNP_capable, and it searches for matches to the 10-digit called telephone number in the LNP-corrected view 28 of the VRR provided by the registry, via the master server 24. There are four possible outcomes:
1. A single 10-digit match is found. In this case, the number is a VoIP reachable telephone, either registered with its own URI or ported to an LRN that has a URI, and the call can be immediately routed to the URI associated with the found record.
2. Two 10-digit matches are found. In this case, the number is a VoIP reachable telephone number that is in the process of being ported. The resolver will examine the “Effective Date/Time” fields in the matching records to determine which of the URI's should be used, and then routing to the associated URI for that record can be performed.
3. No 10-digit match, but a 6-digit match is found. In this case, the telephone number is in either a traditional PSTN number reachable thru a PSTN gateway or it is within a block of VoIP reachable numbers. Since central portability correction has already accounted for any ported exceptions in this NXX, the call can be immediately routed to the URI associated with the found record.
4. No match is found. In this case, the number is not a VoIP reachable number and there is no gateway provided for the specific NPA-NXX number block. So the call must be passed to any available PSTN portal for completion.

Variations on Method II include direct computation of LRN-related URIs in the registry or download of URIs for LRN's NXXs with separate mappings of 10-digit numbers to those LRNs or their NXXs.

Using this overall architecture and the resolver retrieval methods described above, the following conclusions are drawn:

With Method I, calls can be very rapidly routed since 10-digit numbers will be directly translated into their destination URI provided they are not in the process of being actively ported. This requires only a single lookup. For numbers that are being ported, additional database checks must be made but only until porting has been completed and the older VRR database entry has been removed from effective status.

With Method I, by performing the LNP correction “downstream” at service providers' resolver end systems rather than in the registry, portability will be done in a timely manner and with very low overhead for keeping the registry up-to-date. Thus, the VRR registry does not have to rapidly assimilate LNP changes in real-time since both the original carrier's URI and the new carrier's URI can coexist in the registry.

With Method II, the need for an LNP-capable resolver is eliminated, which may lead to significant cost savings in the resolver location. The registry for Method II is more capable, and must be enhanced to provide timely computation of LNP corrections based on real-time changes in LNP data.

These methods are also applicable to 15-digit international numbers or city-country codes which could co-exist with the 10-digit and 6-digit records as described.

The 6-digit number blocks can be associated with either VoIP gateways to the PSTN or blocks of VoIP numbers enabling efficient coding of the database resulting in low costs and maximizing synergy with the PSTN. Since a majority of the calls originated from VoIP telephones will be destined for the PSTN, this is an important capability.

In summary, the primary advantages of the VoIP routing registry architecture and resolver retrieval method are as follows:
Supporting 10-digit telephone numbers and 6-digit telephone number blocks. This provides flexibility to service providers and a compact database implementation.
Providing a graceful transition to VoIP and improved routing to PSTN gateways. By holistically integrating PSTN and VoIP data, service providers can have greater control over their networking strategies.
By using a secure VPN for interconnection, the VRR data is safer from hacking and denial-of-service attacks and only authenticated service providers can access the information.
For those carriers maintaining legacy PSTN systems, VRR can be easily integrated into their existing methods and procedures if desired.
With Method I, VRR utilizes local number portability for resolving ported/pooled numbers at its resolver in a way that minimizes the local number portability query rates for VoIP, limiting queries to only those situations where 10-digit information is unavailable. This approach also has low overhead costs for the VRR registry.
With Method II, VRR utilizes local number portability for resolving ported/pooled numbers in the registry in a way that eliminates direct call-time portability queries for VoIP.
The VRR resolver always has all the data, a fact that ensures very low impact on call set-up delay.
Only VRR allows service providers to specify a different URI depending on the identity of the requesting operator, a capability that supports business plans, mergers and partnerships to more closely integrate their networks.

Having described and illustrated a system, method and architecture for creating a VoIP routing registry and resolver retrieval method, it will be apparent to those skilled in the art that modifications and variations are possible without deviating from the teachings and broad principles of the present invention which shall be limited solely by the scope of the claims appended hereto.

What is claimed is:

1. A system for VoIP call routing comprising:
a registry of records stored in a database that maps individual telephone numbers or blocks of telephone numbers to their network entry point URIs; and
a master server connected to said registry which provides a data feed to VoIP services providers of information regarding routes associated with groups of telephone numbers.

2. The system of claim 1 further comprising a server in the service provider's network for receiving said routing information from said master server and for resolving all call routing requests received by said service provider.

3. The system of claim 1 wherein said records in said registry is further comprised of 10 digit telephone numbers associated with the URI for routing the VoIP call.

4. The system of claim 3 wherein said registry further includes an effective date and time for when said associated URI is active for said 10 digit telephone number.

5. The system of claim 1 wherein said records in said registry is further comprised of 6 digit numbers representing gateways to the public switched telephone network and an associated URI.

6. The system of claim 5 wherein said registry further includes an effective date and time for when said associated URI is active for said 6 digit telephone number.

7. A method for delivering routing information to VoIP service providers comprising the steps of:
creating a record of telephone numbers and associated URI's for each VoIP service provider in a data base;
periodically transmitting to one VoIP service provider information associating of telephone numbers with URI's for all other service providers that said one service provider will route VoIP calls.

8. A method of routing calls in a VoIP network comprising the steps of:
delivering to a service provider information that associates telephone numbers and URI addresses;
searching for a match between the called party received by said service provider by a customer making a call with said telephone number within said information delivered;
routing said call based on the URI information associated with said telephone number matching said called party number.

9. The method of claim 8 wherein said telephone numbers are 10 digit numbers.

10. The method of claim 9 wherein said routing step further comprises the steps of:
checking with a local number portability database to determine if an associated local routing number exists; and
if a local routing number is found, routing the call to the URI associated with said local routing number.

11. The method of claim 8 wherein said routing step further includes routing the call in accordance with effective date and time information stored with said URI associated with said telephone number.

12. The method of claim 7 wherein the step of periodically downloading information to said service providers is completed a least once per day.
